(19) United States
(12) Patent Application Publication
(10) Pub. No.: US 2008/0291488 A1
(43) Pub. Date: Nov. 27, 2008

(54) Image processing apparatus

(76) Inventors: San Wei Lin, Luodong Township (TW); Chih-Mao Lin, Keelung City (TW); Yun Ling Chang, Taipei City (TW); Chen-Hsiu Weng, Jhonghe City (TW); Yon-Fon Kuo, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,415

(22) Filed: Oct. 12, 2007

(30) Foreign Application Priority Data
May 23, 2007 (TW) 096208411

(51) Int. Cl. G06K 1/00

(52) U.S. Cl. 358/1.15

(57) ABSTRACT

An image processing apparatus includes an electronic device, a network and a server. The electronic device has a transmitting unit and a receiving unit, and the transmitting unit provides at least one image data. The network is connected to the electronic device for transmitting the image data. The server is connected to a network for receiving an image data. The server has an image processing unit for detecting a feature of the image data, synthesizing the image data with a media object based on the feature, retrieving the feature to perform one of the synthesis methods with the media object to generate a synthesized image data, and transmitting the synthesized image data to the receiving unit via a network.

### BACKGROUND OF THE INVENTION

1. Field of the Invention

The present invention relates to an image processing apparatus, and more particularly to a technical field of providing an image data by an electronic device, and transmitting the image data to a remote server via a network for a synthesis, and returning a synthesized image data to the electronic device.

2. Description of the Related Art

Since audio/video multimedia technology is developed rapidly, people have increasingly higher demands on recreation and fun of an electronic device (such as a mobile phone or a computer) and an image processing apparatus. For instance, a colorful background image data, a virtual animation or a multimedia video is added into an image data captured by a mobile phone, or an image synthesis process is performed by a computer to generate a synthesized image data with a special effect similar to a TV movie or a computer game.

Although some of the conventional mobile phones come with built-in background image data and allow users to select a background image data to be synthesized with the captured image data through the mobile phone to generate a synthesized image data, yet such prior art still has the drawback that the background image data usually being a still image which does not have the special effects of a virtual animation. In addition, the common mobile phone does not have an image processing function, and thus it is difficult to achieve the desired special effects.

Although some of the conventional computers have image processing function and allow users to synthesize an image data through an image processing software and generate a synthesized image data, yet the image processing function is limited (without an image identification function), lack of a media object (without a virtual animation), or the processing speed of the computer is too slow, or lack of a professional image processing capability, and thus it is difficult for the conventional computers to provide a synthesized image data with special effects.

To overcome the drawbacks of the prior art and satisfy users requirements for the image processing apparatus and the electronic device having an image processing function, the inventor of the present invention based on years of experience in the related industry to conduct extensive researches and experiments, and finally developed an image processing apparatus in accordance with the present invention to overcome the aforementioned drawbacks.

### SUMMARY OF THE INVENTION

It is a primary objective of the present invention to provide an image processing apparatus and an electronic device having an image processing function, particularly in a technical field that the electronic device provides an image data and transmits the image data to a remote server via a network to perform a synthesis and a synthesized image data will be returned to the electronic device, so as to satisfy the user requirement for an image processing apparatus and an electronic device having an image processing function to overcome the drawbacks of the prior art. Therefore, the electronic device without the image processing function also can generate a synthesized image data with special effects easily.

To achieve the foregoing objective, the present invention provides an image processing apparatus comprising an electronic device, a network and a server. The electronic device has a transmitting unit and a receiving unit, and the transmitting unit provides at least one image data. The network is connected to the electronic device for transmitting the image data. The server is connected to the network for receiving the image data. The server has an image processing unit for detecting a feature of the image data, and synthesizing an image data with a media object based on the feature, or retrieving the feature to synthesize with the media object, so that the image processing unit can generate a synthesized image data and transmit the synthesized image data to the receiving unit via the network.

To achieve the foregoing objective, the present invention provides an electronic device having an image processing function, and the electronic device communicates with a remote server via a network, and the remote server has an image processing unit and a media object. The electronic device comprises a transmitting unit and a receiving unit. The transmitting unit transmits at least one image data to a remote server through the network. The image processing unit detects feature of the image data for synthesizing the image data with a media object based on the feature, or retrieving the feature to synthesize with the media object, so that the image processing unit can generate a synthesized image data. The receiving unit receives the synthesized image data from the remote server via the network.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The subject matter regarded as the invention is particularly pointed out and distinctly claimed in the concluding portion of the specification. The invention together with features and advantages thereof may best be understood by reference to the following detailed description with the accompanying drawings in which:

FIG. 1 is a schematic view of an image processing apparatus in accordance with a first preferred embodiment of the present invention,

FIG. 2 is a schematic view of an image processing apparatus in accordance with a second preferred embodiment of the present invention,

FIG. 3A is a schematic view of displaying an image data in accordance with the present invention, and

FIG. 3B is a schematic view of synthesizing an image data in accordance with the present invention.

### DETAILED DESCRIPTION OF THE PREFERRED EMBODIMENTS

The present invention relates to an image processing apparatus. While the specifications describe at least one embodiment of the invention considered best modes of practicing the invention, it should be understood that the invention can be implemented in many ways and is not limited to the particular examples described below or to the particular manner in which any features of such examples are implemented.

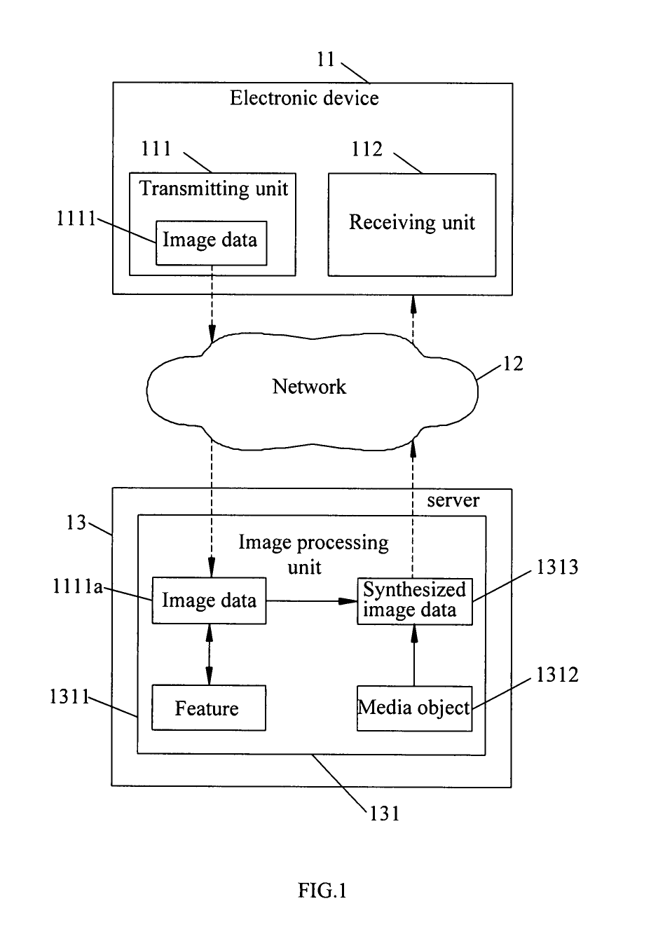

Please referring to FIG. 1 for a schematic view of an image processing apparatus in accordance with a first preferred embodiment of the present invention, the image processing apparatus comprises an electronic device 11, a network 12 and a server 13. Preferably, the electronic device 11 is a mobile phone, a computer, a camera or a personal digital assistant, and comprises a transmitting unit 111 and a receiving unit 112. The transmitting unit 111 is for providing at least one image data 1111, such as a human body image data or an object image data. Preferably, the electronic device 11 can install an image capturing unit, such as a camcorder device or a camera device, for capturing the image data 1111. The electronic device 11 usually includes a storage unit, such as a memory, for storing the image data 1111 and the synthesized image data 1313.

The network 12 may alternatively be provided as for example, a cable network (such as the Internet or a local area network) or a wireless network (such as a wireless communication network). The network 12 is connected to an electronic device 11 for transmitting the image data 1111. Further, the server 13 is connected to the network 12 for receiving the image data 1111. The server 13 has an image processing unit 131 for detecting a feature 1311 of an image data 1111a (which is also the image data 1111), and synthesizing the image data 1111a with a media object 1312 based on the feature 1311 to generate a synthesized image data 1313 and transmit the synthesized image data 1313 to the receiving unit 112 via the network 12. For example, the image processing unit 131 can detect a facial feature position of a human body image and synthesizes the human body image with a virtual object based on the facial feature position to generate a synthesized image data 1313 and transmit the synthesized image data 1313 to the receiving unit 112 via the network 12.

It is noteworthy to point out that the image processing unit 131 also can have many functions such as adjusting a position, a size or a resolution of the image data 1111a, adding a text data into the synthesized image data 1313, or synthesizing the media object with a plurality of continuous image data 1111a. Preferably, the feature 1311 includes a human body position, an object position, a face position, a facial feature position, a hair position, a finger position, a limb position or a combination of the above. Preferably, the media object 1312 includes a two-dimensional model (such as a plane virtual object), a three-dimensional model (such as a solid or dynamic virtual object), an audio data (such as music) or a combination of the above.

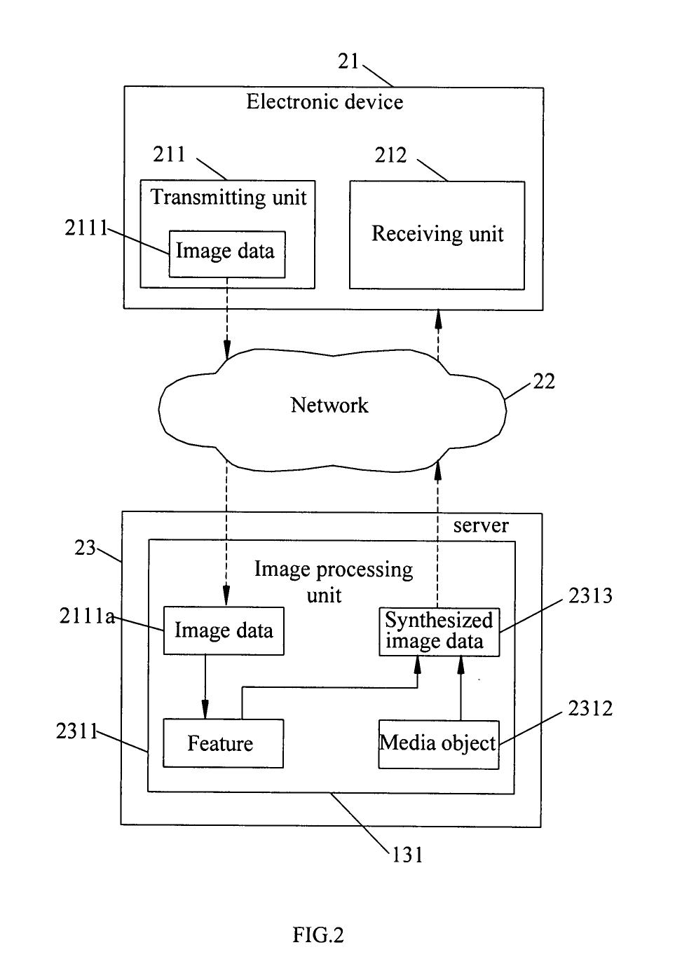

Please referring to FIG. 2 for a schematic view of an image processing apparatus in accordance with a second preferred embodiment of the present invention, the image processing apparatus comprises an electronic device 21, a network 22 and a server 23. Preferably, the electronic device 21 is a mobile phone, a computer, a camera or a personal digital assistant, and has a transmitting unit 211 and a receiving unit 212. The transmitting unit 211 is for providing at least one image data 2111, such as a human body image data or an object image data. The electronic device 21 can install an image capturing unit, such as a camcorder device or a camera device, for capturing the image data 2111. The electronic device 21 further includes a storage unit, such as a memory, for storing the image data 2111 and the synthesized image data 2313.

The network 22 may alternatively be provided as for example, a cable network (such as the Internet or a local area network) or a wireless network (such as a wireless communication network). The network 22 is connected to an electronic device 21 for transmitting the image data 2111. The server 23 is connected to the network 22 for receiving the image data 2111. The server 23 includes an image processing unit 231 for detecting a feature 2311 of an image data 2111 a (which is the image data 2111) and synthesizing the feature 2311 with a media object 2312 to generate a synthesized image data 2313, and then transmit the synthesized image data 2313 to the receiving unit 212 via the network 22. For example, the image processing unit 231 detects a face position of a human body image, and retrieves the whole face to synthesize with a virtual character to generate a synthesized image data 2313, and then transmits the synthesized image data 2313 to the receiving unit 212 via the network 22.

It is noteworthy to point out that the image processing unit 231 also can come with many functions, such as adjusting a position, a size or a resolution of the image data 2111a, adding a text data into the synthesized image data 2313, or synthesizing the media object 2312 with a plurality of continuous image data 2111a. Preferably, the feature 2311 includes a human body position, an object position, a face position, a facial feature position, a hair position, a finger position, a limb position or a combination of the above. Preferably, the media object 2312 includes a two-dimensional model (such as a plane virtual object), a three-dimensional model (such as a solid or dynamic virtual object), an audio data (such as music) or a combination of the above.

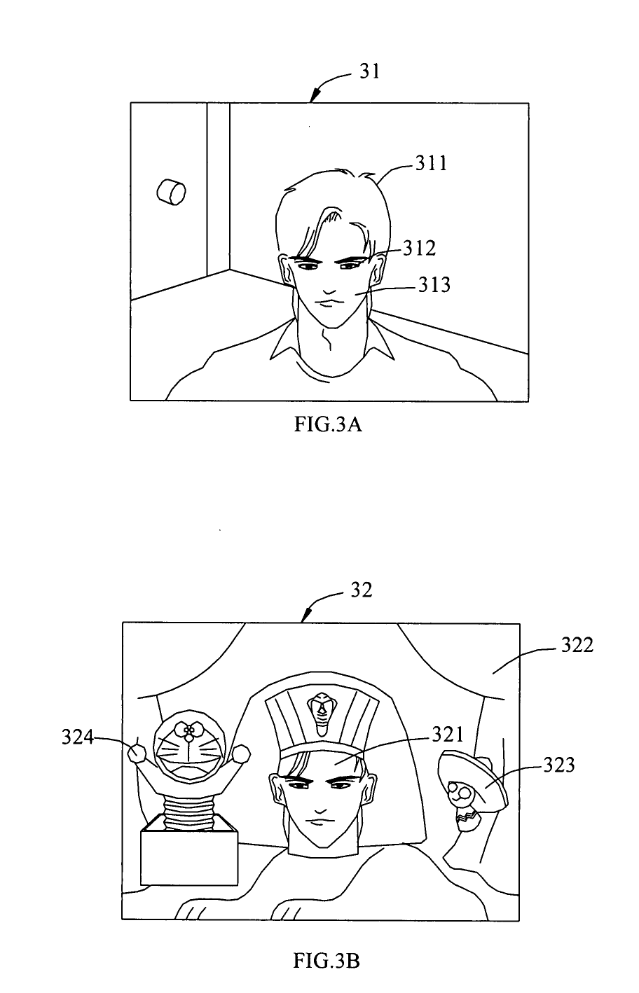

Please referring to FIG. 3A for a schematic view of displaying an image data, the image data 31 is a human body image data, which is captured by an electronic device or stored in an electronic device, such as an image file captured by an image capturing unit of a mobile phone or a digital camera, or an image file stored in a memory of a computer. At the beginning of the process, a transmitting unit of the electronic device provides one or more image data 31, and then the transmitting unit is connected to a network. For example, a cable network (such as the Internet or a local area network) or a wireless network (such as a wireless communication network) is provided for transmitting the image data 31, and the network is connected to a server for receiving the image data 31. The server has an image processing unit for detecting feature of the image data 31 such as a hair position 311, an eye position 312 or a face position 313, and synthesizing the feature.

Please referring to FIG. 3B for a schematic view of a synthesized image data in addition to FIG. 3A, a server is connected to a network to receive the image data 31 as shown in FIG. 3A before the synthesis is performed, and then the image processing unit of the server detects a feature of the image data 31, such as a hair position 311, an eye position 312 or a face position 313, and synthesizes the image data 31 with a media object based on the feature to generate a synthesized image data 32. The synthesized image data 32 includes a face 321 of a human body image, a foreground image data 322, a first virtual object 323, or a second virtual object 324. Further, an audio data can be added into the synthesized image data 32, so that the image data 31 becomes a synthesized image data 32 having a dynamic effect or a special video effect. In another way, the image processing unit can retrieve feature such as a face 321 from the image data 31 to synthesize the face 321 with a media object to produce a special interactive effect between the face 321 and the media object.

While the present invention has been described by way of example and in terms of a preferred embodiment, it is to be understood that the present invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing apparatus, comprising:
an electronic device, having a transmitting unit and a receiving unit, and the transmitting unit providing at least one image data;
a network, connected to the electronic device, for transmitting the image data; and
a server, connected to the network, for receiving the image data, and the server having an image processing unit, wherein the image processing unit is for detecting a feature of the image data, and synthesizing the image data with a media object based on the feature, or retrieving the feature to synthesize with the media object, so that the an image processing unit can generate a synthesized image data and transmit the synthesized image data to the receiving unit via the network.

2. The image processing apparatus of claim 1, wherein the electronic device includes a mobile phone, a computer, a camera or a personal digital assistant.

3. The image processing apparatus of claim 1, wherein the electronic device further comprises an image capturing unit for capturing the image data.

4. The image processing apparatus of claim 1, wherein the electronic device further comprises a storage unit for storing the image data and the synthesized image data.

5. The image processing apparatus of claim 1, wherein the network includes a cable network or a wireless network.

6. The image processing apparatus of claim 1, wherein the image processing unit has function of adjusting a position, a size or a resolution of the image data.

7. The image processing apparatus of claim 1, wherein the image processing unit has function of adding a text data into the synthesized image data.

8. The image processing apparatus of claim 1, wherein the image processing unit synthesizes the media object with a plurality of continuous image data.

9. The image processing apparatus of claim 1, wherein the image data includes a human body image data or an object image data.

10. The image processing apparatus of claim 1, wherein the feature includes a human body position, an object position, a face position, a facial feature position, a hair position, a finger position, a limb position or a combination of the above.

11. The image processing apparatus of claim 1, wherein the media object includes a two-dimensional model, a three-dimensional model, an audio data or a combination of the above.

12. An electronic device capable of processing images, and the electronic device communicating with a remote server via a network, and the remote server having an image processing unit and a media object, and the electronic device comprising:
a transmitting unit, for transmitting at least one image data to the remote server by the network, wherein the image processing unit detects a feature of the image data, and the image processing unit then synthesizes the image data with the media object based on the feature, or retrieves the feature to synthesize with the media object, so that the image processing unit can generate a synthesized image data; and
a receiving unit, for receiving the synthesized image data transmitted from the remote server via the network.

13. The electronic device of claim 12, wherein the electronic device is a mobile phone, a computer, a camera or a personal digital assistant.

14. The electronic device of claim 12, further comprising an image capturing unit for capturing the image data.

15. The electronic device of claim 12, further comprising a storage unit for storing the image data and the synthesized image data.

16. The electronic device of claim 12, wherein the network includes a cable network or a wireless network.

17. The electronic device of claim 12, wherein the image processing unit has function of adjusting a position, a size or a resolution of the image data.

18. The electronic device of claim 12, wherein the image processing unit has function of adding a text data into the synthesized image data.

19. The electronic device of claim 12, wherein the image processing unit synthesizes the media object with a plurality of continuous image data.

20. The electronic device of claim 12, wherein the image data includes a human body image data or an object image data.

21. The electronic device of claim 12, wherein the feature includes a human body position, an object position, a face position, a facial feature position, a hair position, a finger position, a limb position or a combination of the above.

22. The electronic device of claim 12, wherein the media object includes a two-dimensional model, a three-dimensional model, an audio data or a combination of the above.
